(19) United States
(12) Patent Application Publication
(10) Pub. No.: US 2009/0161597 A1
(43) Pub. Date: Jun. 25, 2009

(54) SYSTEM AND METHOD FOR A NEXT GENERATION WIRELESS ACCESS VIA A CONDITIONAL ENABLEMENT

(76) Inventor: Syam Madanapalli, Bangalore (IN)

Correspondence Address: GLOBAL IP SERVICES, PLLC, 10 CRESTWOOD LANE, NASHUA, NH, 03062, US

(21) Appl. No.: 12/337,644

(22) Filed: Dec. 18, 2008

(30) Foreign Application Priority Data
Dec. 24, 2007 (IN) 3083/CHE/2007

(51) Int. Cl. H04W 76/00; H04B 7/14

(52) U.S. Cl. 370/315; 370/338

(57) ABSTRACT

A system and method for a next generation wireless access via a conditional enablement is disclosed. In one embodiment, a method of providing data communication access in an Internet Protocol (IP) network system includes enabling a first link connecting an access device to an Internet source, and enabling a second link connecting an end-user device to the access device upon successfully establishing the first link. The method further includes performing an address configuration by the end-user device by enabling the data communication access, and implementing IP packet bridging by the access device for transmitting one or more data packets between the end-user device and the Internet source.

### RELATED APPLICATIONS

This application claims priority under 35 U.S.C. 119 to India Provisional Application, Serial No. 3083/CHE/2007, entitled “A METHOD AND SYSTEM FOR NEXT GENERATION WIRELESS ACCESS” by Ordyn Technologies Pvt. Ltd., filed on Dec. 24, 2007, which is incorporated herein its entirety by reference.

### FIELD OF TECHNOLOGY

Embodiments of the present invention relate to the field of wireless communication. More particularly, embodiments of the present invention relate to a system and method for a next generation wireless access via a conditional enablement.

### BACKGROUND

Current cellular networks, such as General Packet Radio Service (GPRS), Enhanced rate for GSM Evolution (EDGE) and Third-Generation (3G), are typically configured to connect myriad wireless devices to a telecommunication network. Higher network traffic and limited network resources are typical attributes of the current cellular networks. These networks typically use a point-to-point protocol for a device to connect to these networks for data access, which brings an additional overhead. Several attempts have been made to increase data transmission efficiency while reducing the operating cost of the device. Further, future wireless networks are based on an All-IP architecture, which avoids the usage of the point-to-point protocol.

Furthermore, wireless devices for data access typically have two interfaces: one for connecting to a service network through a base station (e.g., Worldwide Interoperability for Microwave Access (WiMAX), Fourth-Generation (4G), etc.), henceforth called access interface, and another interface for connecting the end-user devices to the wireless device, e.g., laptop (with the Ethernet, Wireless Industrial Networking Alliance (WINA), Bluetooth, etc.), henceforth called local interface. The two interfaces of a wireless device must be established before any packets can be transmitted. In practice, both the interfaces may not be connected at the same time. When the local interface comes up first (i.e., connected), the end-user device may start sending packets to the wireless device, e.g., to obtain an IP address. This causes a problem as the wireless device cannot send any packet to the service network since the access interface is still not functional (i.e., not connected). Therefore, there is a need for a novel solution to address this problem.

### SUMMARY

A system and method for a next generation wireless access via a conditional enablement is disclosed. According to one aspect of the present invention, a method of providing data communication access in an Internet Protocol (IP) network system includes enabling a first link connecting an access device to an Internet source, and enabling a second link connecting an end-user device to the access device upon successfully establishing the first link. The method further includes performing an address configuration by the end-user device by enabling data communication access, and implementing IP packet bridging by the access device for transmitting one or more data packets between the end-user device and the Internet source.

According to another aspect of the present invention, a wireless communication system to provide data communication access in an IP network system includes an air interface module configured to enable a first link connecting an access device to an Internet source, and a local interface module configured to enable a second link connecting an end-user device to the access device upon successfully establishing the first link. The wireless communication system further includes an end-user device configuration module configured to perform an address configuration by enabling data communication access, and a control module configured to implement IP packet bridging for transmitting one or more data packets between the end-user device and the Internet source.

According to yet another aspect of the present invention, a method of providing data communication access in an IP network system includes disabling a second link connecting an end-user device to an access device, and enabling a first link connecting the access device to an Internet source. The method further includes determining whether the first link is enabled, and if the first link is not enabled, then attempting to enable the first link until the first link is enabled. Furthermore, the method includes enabling the second link after successful enablement of the first link, and transmitting one or more data packets between the end-user device and the Internet source after switching the Medium Access Control (MAC) address in the one or more data packets.

The methods and systems disclosed herein may be implemented by any means for achieving various aspects, and may be executed in a form of a machine readable medium embodying a set of instructions that, when executed by a machine, causes the machine to perform any of the operations disclosed herein.

### BRIEF DESCRIPTION OF THE DRAWINGS

Embodiments of the present invention are illustrated by way of examples and not limited to the figures of the accompanying drawings, in which like references indicate similar elements and in which:

FIG. 1 shows a block diagram of a typical wireless communication system using a modem device to transmit one or more data packets from end-user devices to a base station;

FIG. 2 shows a block diagram of another typical wireless communication system using a point-to-point connection;

FIG. 3 shows a block diagram of major functional modules of an access device, according to one embodiment, used for providing data communication access in an Internet Protocol (IP) network system;

FIG. 4 shows a block diagram of various modules associated with the major functional modules as shown in FIG. 3, according to one embodiment;

FIG. 5 shows a process flow chart of an exemplary method of providing data communication access in the IP network system, according to one embodiment;

FIG. 6 shows a block diagram of an exemplary wireless communication system with the access device connecting a single end-user device to an Internet source, according to one embodiment, for providing data communication access in an IP network system;

FIG. 7 shows a process flow chart of an exemplary method of providing data communication access in an IP network system, according to another embodiment; and

FIG. 8 shows a block diagram of another exemplary wireless communication system with an access device connecting one or more end-user devices to the Internet source, according to one embodiment, for providing data communication access in an IP network system.

Other features of the present embodiments will be apparent from the accompanying drawings and from the detailed description that follows.

### DETAILED DESCRIPTION

A system and method for a next generation wireless access via a conditional enablement is disclosed. In the following detailed description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined only by the appended claims.

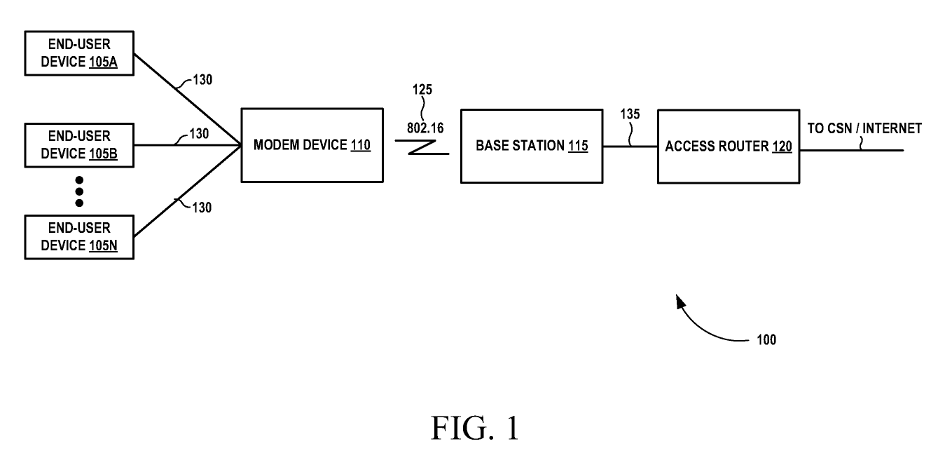

FIG. 1 shows a block diagram of a typical wireless communication system 100 using a modem device 110 to transmit one or more data packets from end-user devices 105A through 105N to a base station 115. As shown in FIG. 1, each of the end-user devices 105A through 105N is connected to the base station 115 via the modem device 110. The modem device 110 is connected to the base station 115 via a link 125 (e.g., per IEEE 802.16 standards) and each of the end-user devices 105A through 105N is connected to the modem device 110 via link 130. The base station 115 is connected to an access router 120 (via link 135) linking with the Connectivity Service Network (CSN)/Internet.

Typically, in an Internet Protocol (IP) network system, such as the wireless communication system 100, the modem device 110 provides connectivity to the end-user devices 105A through 105N. It should be noted that, in providing the connectivity to the end-user devices 105A through 105N, the modem device 110 requires various Open Systems Interconnections (OSI) Layer 3 functionalities, such as routing, Network Address Translation (NAT), Dynamic Host Configuration Protocol (DHCP) client and server and so on, which is costly for a single user needing to connect a single end-user device for accessing a network.

Further, links 125 and 130 should always be established for transmitting the one or more data packets from the end-user devices 105A through 105N to the base station 115. However, in practice, it is possible that both links 125 and 130 would not be established simultaneously. When link 130 comes up first (i.e. connected), the end-user device 105 may start IP parameter acquisition procedures. However, the end-user devices 105A through 105N may not be able to send data packets to the base station 115 until the link 125 is established. Therefore, the end-user devices 105A through 105N may give up the IP parameter requisition procedures, which requires manual intervention, or may retry the IP parameter requisition procedures at a later point in time, thereby causing delay in the wireless communication system 100 becoming operational. Further, the modem device 110 is not optimized for situations where the end-user devices 105A through 105N want to access only the network and not the inter-device connectivity between the end-user devices 105A through 105N.

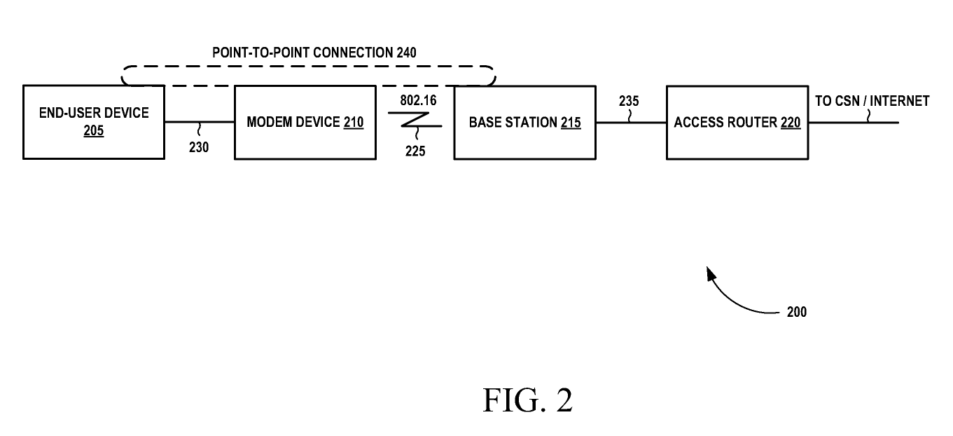

FIG. 2 shows a block diagram of another typical wireless communication system 200 using a point-to-point connection 240. Particularly, the wireless communication system 200 includes an end-user device 205 connected to a modem device 210 via link 230, a base station 215 connected to the modem device 210 via link 225 and an access router 220 connected to the base station 215 via link 235 which gives access to the CSN/Internet.

In a typical IP network system, such as the wireless communication system 200, the connection (i.e., link 230) between the end-user device 205 and the modem device 210 and connection (i.e., link 225) between the modem device 210 and the base station 215 collectively form the point-to-point connection 240. Further, it is a common practice within the IP network system to identify whether the point-to-point connection 240 between the end-user device 205 and the access router 220 is enabled via the point-to-point connection 240 prior to transmitting data packets from the end-user device 205 to the modem device 210.

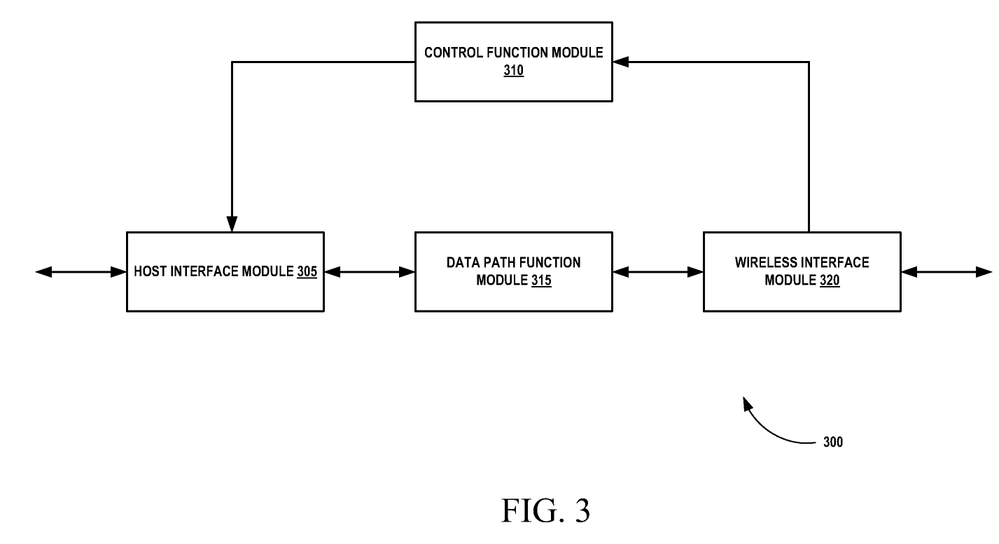

Typically, only after verifying that the point-to-point connection 240 is enabled, the wireless communication system 200 allows the end-user device 205 to transmit data packets to the modem device 210, which then forwards the data packets to the base station 215 and beyond. Since the data transmission occurs subsequent to the verification of the point-to-point connection 240, the wireless communication system 200 is not concerned about losing the data packets. Further, without the verification, it is difficult for the wireless communication system 200 to ensure that the data packets would not be lost during the data transmission. Consequently, the wireless communication system 200 that does not use the point-to-point connection 240 may experience significant data and data management overheads. The present invention contemplates an access device for a next generation wireless access (e.g., Worldwide Interoperability for Microwave Access (WiMAX) networks based on 802.16) which attempts to overcome the above-referred problems. Further, various embodiments of the access device for the next generation wireless access is described in greater detail in FIGS. 3-8.

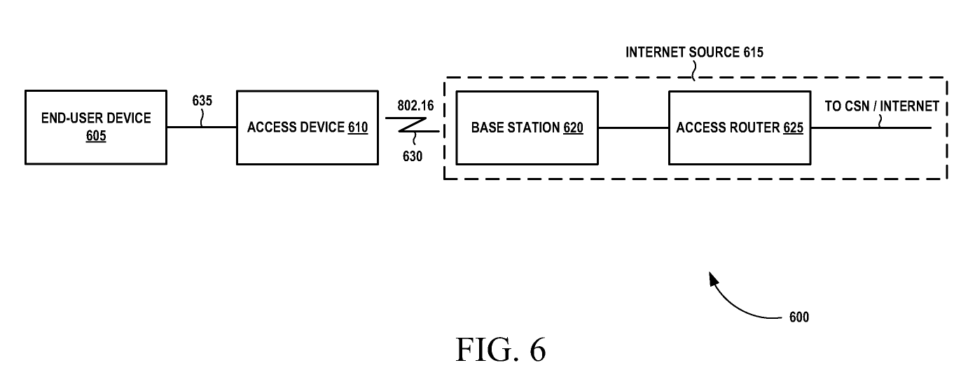

FIG. 3 shows a block diagram 300 of major functional modules of an access device (e.g., the access device 610 of FIG. 6), according to one embodiment, used for providing data communication access in an IP network system. Particularly, FIG. 3 shows a host interface module 305, a control function module 310, a data path function module 315 and a wireless interface module 320. The host interface module 305 provides one or more interfaces for connecting the access device to one or more end-user devices (e.g., the end-user device 605 of FIG. 6). In one example embodiment, the host interface module 305 can be implemented using standard interfaces, such as the Ethernet, Universal Serial Bus (USB), and the like connections.

The control function module 310 provides intelligent logic for the access device. The intelligent logic includes enabling the host interface module 305 upon successfully establishing a first link (e.g., a wireless/wired/partially wired connection) connecting the access device to an Internet source (e.g., the Internet source 615 of FIG. 6). The data path function module 315 implements IP packet bridging for transmitting one or more data packets between the one or more end-user devices and the Internet source, (i.e., to emulate Layer 2 forwarding). The wireless interface module 320 implements a wireless connection (e.g., WiMAX, Third Generation Long Term Evolution (3G LTE), etc.) between the access device and the Internet source. It is appreciated that the above implementation eliminates the need for expensive point-to-point connection for a user attempting to access the Internet source via a single end-user device.

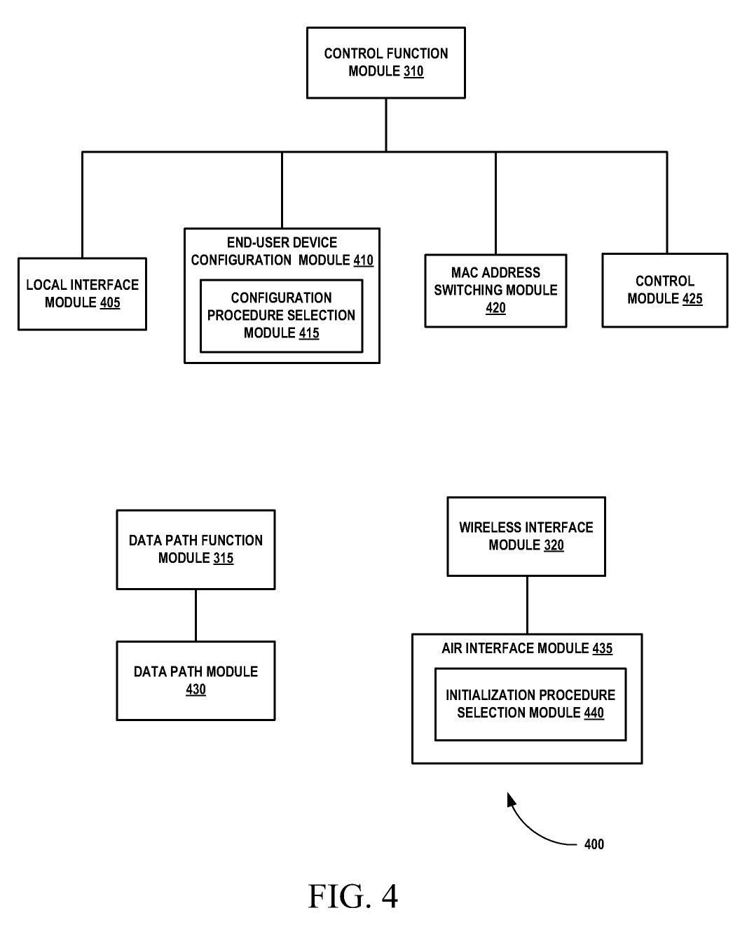

FIG. 4 shows a block diagram 400 of various modules associated with the major functional modules shown in FIG. 3, according to one embodiment. The control function module 310 includes a local interface module 405, an end-user device configuration module 410, a Medium Access Control (MAC) address switching module 420, and a control module 425. The data path function module 315 includes a data path module 430, and the wireless interface module 320 includes an air interface module 435.

In operation, the air interface module 435 is configured to enable the first link connecting the access device to the Internet source. As shown in FIG. 4, the air interface module 435 includes an initialization procedure selection module 440, which is configured to select and perform an initialization procedure. An exemplary initialization procedure may include a channel acquisition procedure, a ranging procedure, an authentication procedure and an authorization procedure. The local interface module 405 is configured to enable a second link (i.e., a wired or a wireless connection) connecting the one or more end-user devices to the access device upon successfully establishing the first link. Further, the local interface module 405 is configured to receive one or more data packets from the end-user devices at the access device via the second link. For example, the one or more data packets include the MAC address of the end-user devices.

The end-user device configuration module 410 is configured to perform an address configuration by enabling data communication access in the IP network system. As shown in FIG. 4, the end-user device configuration module 410 includes a configuration procedure selection module 415, which is configured to select and perform a configuration procedure at each of the end-user devices. An exemplary configuration procedure may include a DHCP, a DHCP for IPv6 and a stateless address auto configuration. In one exemplary implementation, the configuration procedure is performed at each of the end-user devices upon receiving a link up event, denoting that a link between an end-user device and the access device is established using Layer 2 of the OSI model.

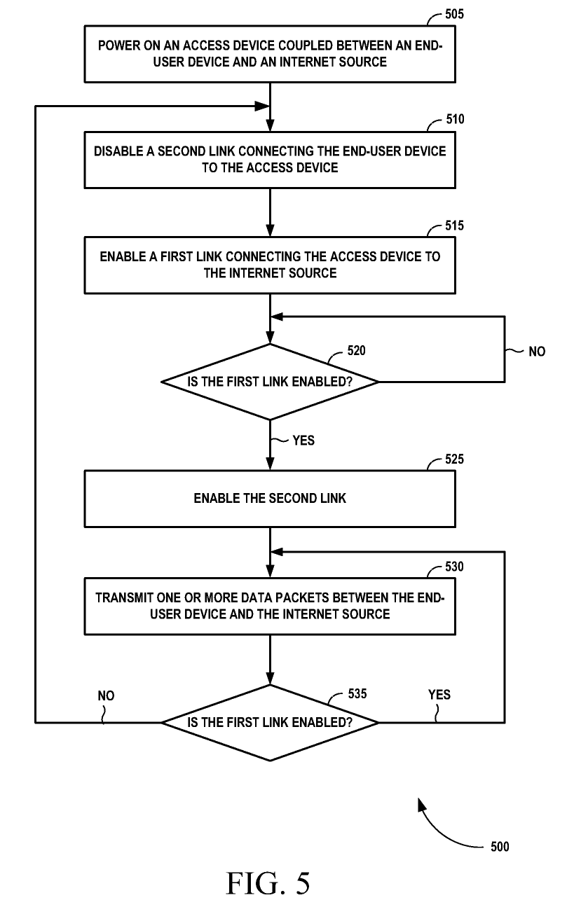

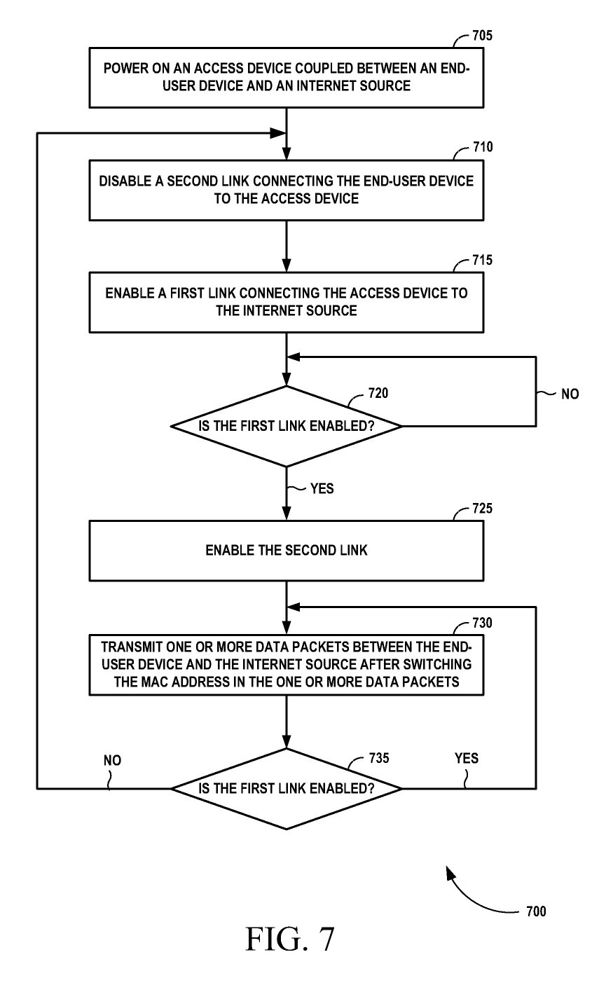

In one embodiment, the MAC address switching module 420 is configured to perform an address switching procedure at the access device by replacing the MAC address of an end-user device in the one or more data packets with the MAC address of the access device if the end-user device is not authenticated (e.g., in case of multi-user/unauthorized access). The control module 425 is configured to implement IP packet bridging for transmitting the one or more data packets between the one or more end-user devices and the Internet source. In one embodiment, the control module 430 is configured to transmit the one or more data packets from the access device to the Internet source via the first link. In one exemplary implementation, the data path module 430 is configured to relay the one or more data packets for transmission without decrementing time to live count. Further, the data path module 430 is configured to convert IP signaling protocols (e.g., IPv4 address resolution protocol, IPv6 neighbor discovery messages, etc.) as required by the Internet source. Further, in accordance with the above-described embodiments, the local interface module 405 is also configured to disable the second link connecting the end-user devices to the access device if the first link is not enabled or disconnected. The method of providing data communication access is explained in greater detail with respect to FIGS. 5 and 7.

FIG. 5 shows a process flow chart 500 of an exemplary method of providing data communication access in an IP network system, according to one embodiment. In one embodiment, the process flow chart 500 shows a method of providing the data communication access when the access device acts as a Layer 2 device. In this embodiment, the access device is an Access Point (AP) and one or more end-user devices are directly authenticated. In step 505, an access device coupled between an end-user device and an Internet source is powered on. In one embodiment, the Internet source includes a base station in communication with an access router linking the CSN/Internet.

In step 510, a second link connecting the end-user device to the access device is disabled. In one example embodiment, the second link is a wired connection or a wireless connection. In step 515, a first link connecting the access device to the Internet source is enabled. In one example embodiment, the first link is a wireless connection. In step 520, a check is made to determine whether the first link connecting the access device to the Internet source is enabled. If the check made in step 520 is false, then the process 500 periodically checks whether the first link is enabled or not until the first link is enabled, else the process 500 performs step 525. It is appreciated that, after performing step 520, the process 500 waits until the first link connecting the access device to the Internet source is enabled, and then goes to step 525 only after the first link connecting the access device to the Internet source is enabled (i.e., after successful enablement of the first link).

In step 525, the second link connecting the end-user device to the access device is enabled. In step 530, one or more data packets are transmitted between the end-user device and the Internet source by the access device. It is appreciated that, the access device implements IP packet bridging for transmitting the one or more data packets between the end-user device and the Internet source. In one embodiment, the IP packet bridging is implemented by relaying the one or more data packets for transmission without decrementing time to live count. In another embodiment, the IP packet bridging is implemented by converting IP signaling protocols as required by the Internet source.

Further, in step 535, a check is made to determine whether the first link connecting the access device to the Internet source is enabled. If the check made in step 535 is false, then the process 500 goes to step 510 and repeats the steps 510-535 until all the data packets are transmitted between the end-user device and the Internet source. Alternatively, if the check made in step 535 is true, i.e., if the first link is enabled, then the process 500 goes step 530 and continues transmission of the one or more data packets between the end-user device and the Internet source. Further, in accordance with the above-described embodiments, an address configuration is performed by the end-user device by enabling data communication access.

FIG. 6 shows a block diagram of an exemplary wireless communication system 600 with an access device 610 connecting a single end-user device 605 to an Internet source 615, according to one embodiment, for providing data communication access in an IP network system. The Internet source 615 includes a base station 620 in communication with an access router 625 linking the CSN/Internet. As shown in FIG. 6, the access device 610 is connected to the Internet source 615 via a first link 630.

Further, as shown in FIG. 6, the end-user device 605 is connected to the access device 610 via a second link 635. It can be seen from FIG. 6 that, the first link 630 is a wireless connection (e.g., per IEEE 802.16 standards), while the second link 635 is a wired connection. Alternatively, the second link 635 may also be a wireless connection. One skilled in the art can envision that the first link 630 and the second link 635 may be a wired, wireless, or partially wired connection.

In operation, the access device 610 enables the first link 630 connecting the access device 610 to the Internet source 615. In one embodiment, the access device 610 disables the second link 635 connecting the end-user device 605 to the access device 610 and then enables the first link 610. Further, the access device 610 enables the second link 635 connecting the end-user device 605 to the access device 610 upon successfully establishing the first link 630. In some embodiments, the access device 610 receives one or more data packets including the MAC address of the end-user device 605 from the end-user device 605 via the second link 635. In one exemplary implementation, the access device 610 performs an address switching procedure by replacing the MAC address of the end-user device 605 with the MAC address of the access device 610 if the end-user device 605 is not authenticated. Furthermore, the access device 610 implements an IP packet bridging for transmitting the one or more data packets between the end-user device 605 and the Internet source 615. Moreover, the access device 610 transmits the one or more data packets to the Internet source 615 via the first link 630. In accordance with the above-described embodiments, the access device 610 disables the second link 635 connecting the end-user device 605 to the access device 610 if the first link 630 is not enabled after performing the address switching procedure.

It is appreciated that the wireless communication system 600 provides simple Layer 2 connectivity (i.e., as opposed to Layer 3 connectivity which requires routing, NAT, DHCP client and server). It is also appreciated that the wireless communication system 600 can obtain IP configuration information (IP address, netmask, IPv6 prefix, Domain Name System (DNS) server address, etc.) from network providers without running point-to-point protocols (e.g., PPP, Packet Data Protocol (PDP) context in 3^{rd} Generation Partnership Projects (3GPP), etc.) between the end-user device 605 and the access router 625. This helps significantly in reducing extra overheads for the networks.

FIG. 7 shows a process flow chart 700 of an exemplary method of providing data communication access in an IP network system, according to another embodiment. The process flow chart 700 shows a method of providing the data communication access when end-user devices are not directly authenticated. In step 705, an access device coupled between an end-user device and an Internet source is powered on. In one embodiment, the Internet source includes a base station in communication with an access router linking the CSN/Internet.

In step 710, a second link connecting the end-user device to the access device is disabled. In one example embodiment, the second link is a wired connection or a wireless connection. In step 715, a first link connecting the access device to the Internet source is enabled. In one example embodiment, the first link is a wireless connection. In step 720, a check is made to determine whether the first link connecting the access device to the Internet source is enabled.

If the check made in step 720 is false, then the process 700 periodically checks whether the first link is enabled or not, until the first link is enabled, else the process 700 performs step 725. It is appreciated that, after performing step 720, the process 700 waits until the first link is enabled, and goes to step 725 only after the first link is enabled (i.e., after successful enablement of the first link). In step 725, the second link connecting the end-user device to the access device is enabled.

In step 730, one or more data packets are transmitted between the end-user device and the Internet source after switching the MAC address in the one or more data packets. In one embodiment, the one or more data packets, including the MAC address of the end-user device, are received from the end-user device to the access device via the second link. In this embodiment, an address switching procedure is performed at the access device by replacing the MAC address of the end-user device in the one or more data packets with the MAC address of the access device and then the one or more data packets are transmitted from the access device to the Internet source via the first link. In an alternate embodiment, the one or more data packets, including the MAC address of the Internet source, are received from the Internet source to the access device via the first link. In this embodiment, an address switching procedure is performed at the access device by replacing the MAC address of the Internet source in the one or more data packets with the MAC address of the access device and then the one or more data packets are transmitted from the access device to the end-user device via the second link.

In accordance with the above-described embodiments, the access device implements IP packet bridging for transmitting the one or more data packets between the end-user device and the Internet source. In one embodiment, the IP packet bridging is implemented by relaying the one or more data packets for transmission without decrementing time to live count. In another embodiment, the IP packet bridging is implemented by converting IP signaling protocols as required by the Internet source.

Further, in step 735, a check is made to determine whether the first link connecting the access device to the Internet source is enabled after performing the address switching procedure. If the check made in step 735 is false, then the process 700 goes to step 710 and repeats the steps 710-735 until all the data packets are transmitted between the end-user device and the Internet source. Alternatively, if the check made in step 735 is true, then the process 700 goes step 730 and continues transmission of the one or more data packets between the end-user device and the Internet source after switching the MAC address in the one or more data packets. Further, in accordance with the above-described embodiments, an address configuration is performed by the end-user device by enabling data communication access.

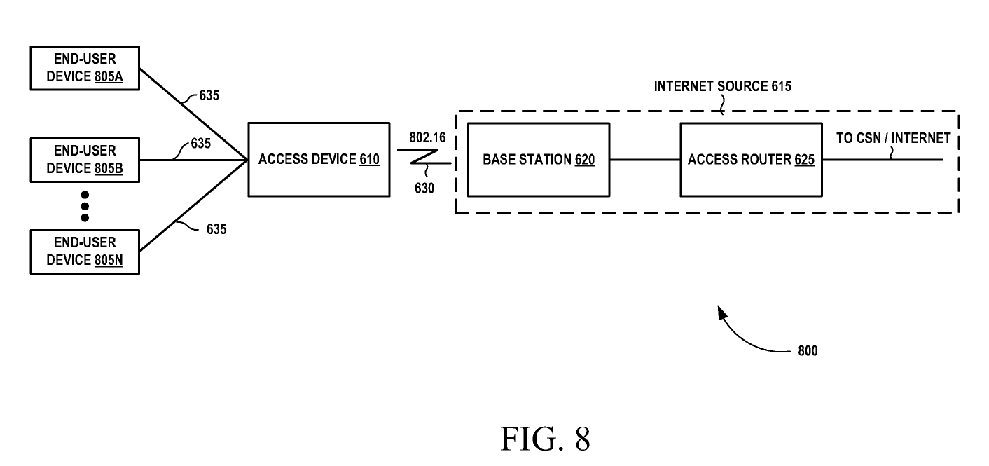

FIG. 8 shows a block diagram of another exemplary wireless communication system 800 with an access device 610 connecting one or more end-user devices 805A through 805N to an Internet source 615, according to one embodiment, for providing data communication access in an IP network system. Each of the end-user devices 805A through 805N is connected to the access device 610 via a second link 635. In one embodiment, the access device 610 acts as an access point to provide data communication access to the one or more end-user devices 805A through 805N, thus providing a simple Layer 2 connectivity, (i.e., as opposed to layer 3 connectivity which requires routing, NAT, and DHCP client and server). It is appreciated that the access device 610 can also provide linkup with other transparent services.

Further, it is appreciated that the wireless communication system 800 is applicable for hotspots, connectivity in public transport (e.g., train, bus, airplane, bus, etc.) applications, in which users can connect to a service provider's network via the access device 610. The operations of the wireless communication system 800 are as explained in the foregoing with reference to FIG. 6.

The above-described system provides an IP interface to end-user devices, which is simulated using the access device. Further, the above-described technique provides a simple Layer 2 connectivity, thereby eliminating the need to implement various Layer 3 functionalities, such as routing, NAT, DHCP, etc. Furthermore, the above-described system allows each end-user devices to run its IP protocols as if the end-user device is connected to a first hop router. In one embodiment, the above-described access device has the ability to obtain IP configuration information (e.g., IP address, netmask, IPv6 prefix, DNS server addresses, etc.) from the network providers without using the point-to-point connection.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., Complementary Metal Oxide Semiconductor (CMOS) based logic circuitry), firmware, software and/or any combination of hardware, firmware, and/or software (e.g., embodied in a machine-readable medium). For example, the various electrical structure and methods may be embodied using transistors, logic gates, and electrical circuits (e.g., Application Specific Integrated Circuitry (ASIC)).

What is claimed is:

1. A method of providing data communication access in an Internet Protocol (IP) network system comprising:
enabling a first link connecting an access device to an Internet source;
enabling a second link connecting an end-user device to the access device upon successfully establishing the first link;
performing an address configuration by the end-user device by enabling the data communication access; and
implementing IP packet bridging by the access device for transmitting one or more data packets between the end-user device and the Internet source.

2. The method of claim 1, wherein the Internet source comprises a base station in communication with an access router linking the Connectivity Service Network (CSN)/Internet.

3. The method of claim 1, wherein the first link is a wireless connection.

4. The method of claim 1, wherein the second link is at least one of a wired connection and a wireless connection.

5. The method of claim 1, wherein implementing the IP packet bridging comprises relaying the one or more data packets for transmission without decrementing time to live count.

6. The method of claim 1, wherein implementing the IP packet bridging comprises converting IP signaling protocols as required by the Internet source.

7. The method of claim 1, further comprises performing an address switching procedure at the access device by replacing the Medium Access Control (MAC) address of the end-user device in the one or more data packets with the MAC address of the access device, if the end-user device is not authenticated.

8. The method of claim 7, further comprises transmitting the one or more data packets from the access device to the Internet source via the first link.

9. A wireless communication system for providing data communication access in an Internet Protocol (IP) network system comprising:
an air interface module configured to enable a first link connecting an access device to an Internet source;
a local interface module configured to enable a second link connecting an end-user device to the access device upon successfully establishing the first link;
an end-user device configuration module configured to perform an address configuration by enabling the data communication access; and
a control module configured to implement IP packet bridging for transmitting one or more data packets between the end-user device and the Internet source.

10. The system of claim 9, wherein the Internet source comprises a base station in communication with an access router linking the Connectivity Service Network (CSN)/Internet.

11. The system of claim 9, wherein the first link is a wireless connection.

12. The system of claim 9, wherein the second link is at least one of a wired connection and a wireless connection.

13. The system of claim 9, further comprising a data path module configured to relay the one or more data packets for transmission without decrementing time to live count.

14. The system of claim 13, wherein the data path module is further configured to convert IP signaling protocols as required by the Internet source.

15. The system of claim 9, further comprising a Medium Access Control (MAC) address switching module configured to perform an address switching procedure at the access device by replacing the MAC address of the end-user device in the one or more data packets with the MAC address of the access device if the end-user device is not authenticated.

16. The system of claim 9, wherein the control module is configured to transmit the one or more data packets from the access device to the Internet source via the first link.

17. A method of providing data communication access in an Internet Protocol (IP) network system comprising:
disabling a second link connecting an end-user device to an access device;
enabling a first link connecting the access device to an Internet source;
determining whether the first link is enabled;
if not, attempting to enable the first link until the first link is enabled;
enabling the second link after successful enablement of the first link; and
transmitting one or more data packets between the end-user device and the Internet source after switching the Medium Access Control (MAC) address in the one or more data packets.

18. The method of claim 17, further comprising:
receiving the one or more data packets from the end-user device to the access device via the second link, wherein the one or more data packets include the MAC address of the end-user device;
performing an address switching procedure at the access device by replacing the MAC address of the end-user device in the one or more data packets with the MAC address of the access device; and
transmitting the one or more data packets from the access device to the Internet source via the first link.

19. The method of claim 17, further comprising:
receiving the one or more data packets from the Internet source to the access device via the first link, wherein the one or more data packets include the MAC address of the Internet source;
performing an address switching procedure at the access device by replacing the MAC address of the Internet source in the one or more data packets with the MAC address of the access device; and
transmitting the one or more data packets from the access device to the end-user device via the second link.

20. The method of claim 17, wherein transmitting the one or more data packets from the access device and the Internet source via the first link further comprises determining if the first link is enabled after performing the address switching procedure.

21. The method of claim 20, further comprises disabling the second link and enabling the first link, if the first link is not enabled after performing the address switching procedure.
